(19) United States
(12) Patent Application Publication
(10) Pub. No.: US 2023/0024806 A1
(43) Pub. Date: Jan. 26, 2023

(54) Oral Irrigator

(71) Applicant: FLY CAT ELECTRICAL CO., LTD., Shenzhen (CN)

(72) Inventors: Xinquan LIU, Shenzhen (CN); Yong TANG, Shenzhen (CN)

(73) Assignee: FLY CAT ELECTRICAL CO., LTD., Shenzhen (CN)

(21) Appl. No.: 17/729,147

(22) Filed: Apr. 26, 2022

(30) Foreign Application Priority Data
Jul. 21, 2021 (CN) 202121671919.5

(51) Int. Cl. A61C 17/02

(52) U.S. Cl. CPC A61C 17/02

(57) ABSTRACT

The present application provides an oral irrigator which includes an irrigator body. The irrigator body includes a water tank, a nozzle, and a cathode plate and an anode plate are provided spaced apart from each other at a bottom of the water tank. The anode plate and the anode plate are electrically connected to a negative electrode and a positive electrode of a power supply component of the oral irrigator, respectively. A water outlet of the water tank is located at the bottom of the water tank. Water in the water tank is electrolyzed by the cathode plate and the anode plate to generate ozone water and hydrogen-rich water, and flow out from the water outlet to the nozzle of the irrigator body to be sprayed out, aiming to solve a problem that the existing oral irrigator only uses water flow for physical cleaning.

### CROSS-REFERENCE TO RELATED APPLICATION

Pursuant to 35 U.S.C. § 119 and the Paris Convention, this application claims the benefit of Chinese Patent Application No. 202121671919.5 filed on Jul. 21, 2021, the entire content of which is incorporated herein by reference.

### TECHNICAL FIELD

The present application relates to the field of nursing product technologies, and more particularly, to an oral irrigator.

### BACKGROUND

The oral irrigator is a home oral care product that uses high-pressure pulsed water to remove food residues trapped in gaps between teeth that toothbrushes and dental floss cannot reach, so as to effectively clean dental plaque, improve gingivitis, reduce gum bleeding, freshen breath and so on. As people pay more attention to personal oral health, oral irrigator is becoming more and more popular.

The basic principle of the oral irrigator is to use a pump to draw water from a water tank, and then through a nozzle, the high-pressure pulsed water is sprayed out to clean the teeth and oral.

The existing oral irrigator only uses high-pressure pulsed water flow for physical cleaning, such as flushing and cleaning, while only perform the physical cleaning cannot provide more efficient oral care.

### SUMMARY

An object of the present application is to provide an oral irrigator, which aims to solve the technical problem that the existing oral irrigator only uses water flow for physical cleaning.

In order to achieve the above object, a technical solution adopted by the present application is to provide an oral irrigator, which includes an irrigator body. The irrigator body includes a water tank and a nozzle. At least one cathode plate and at least one anode plate are provided spaced apart from each other and alternately arranged at a bottom of the water tank. The cathode plate and the anode plate are electrically connected to a negative electrode and a positive electrode of a power supply component of the irrigator body, respectively. A water outlet of the water tank is located at the bottom of the water tank. Water in the water tank is electrolyzed by the cathode plate and the anode plate to generate ozone water and hydrogen-rich water, and flow out from the water outlet to the nozzle of the irrigator body to be sprayed out.

In an embodiment of the present application, a chamber is provided in a bottom plate of the water tank, the cathode plate and the anode plate are provided in the chamber, and the chamber is provided with an opening in communication with the water tank.

In an embodiment of the present application, two cathode plates and one anode plate are provided, and the anode plate is located between the two cathode plates.

In an embodiment of the present application, a distance between adjacent cathode plate and anode plate is less than or equal to 1 mm.

In an embodiment of the present application, the cathode plate and the anode plate both have a material of titanium alloy.

In an embodiment of the present application, the opening is disposed on a surface of the bottom plate, the cathode plate and the anode plate are aligned with the opening, the cathode plate and the anode plate located between the opening and the cathode/anode plate located farthest from the opening are provided with a plurality of through holes.

In an embodiment of the present application, between the adjacent cathode plate and anode plate, between the cathode plate at the bottom and a bottom surface of the chamber, and between the cathode plate at the top and a top surface of the chamber, insulating annular seals are provided respectively, and the opening is located at an inner side of the insulating annular seal between the cathode plate at the top and the top surface of the chamber.

In an embodiment of the present application, the irrigator body further includes a pump body and a motor matching the pump body, an inlet of the pump body is in communication with the water outlet of the water tank, and an outlet of the pump body is in communication with the nozzle of the irrigator body.

In an embodiment of the present application, the cathode plate and the anode plate are circular in shape.

In an embodiment of the present application, the inlet of the pump body is connected to the water outlet of the water tank through a connection pipe.

The oral irrigator provided by the present application has beneficial effect in that: compared with the existing technology, the present application is provided with a cathode plate and an anode plate, being connected to a negative electrode and a positive electrode of the power supply component, respectively, which enables the ozone water and hydrogen-rich water to be directly and quickly prepared through a low-pressure electrolysis of water.

Among them, the role of ozone water is to quickly and effectively kill virus bacteria virus bacteria such as tuberculosis, Escherichia coli, gonococcus, typhoid bacillus, etc. as well as harmful microorganisms in teeth and oral cavity. It can produce sterile water, which is harmless to the human body. It also can remove bad breath and bleach tooth discoloration and dirt.

Among them, the role of hydrogen-rich water is to eliminate excessive active oxygen free radicals in the human body, and improve the sub-health state of the human body. It also has strong antioxidant capacity and can improve the oxidative damage to the human body in the process of various diseases.

### BRIEF DESCRIPTION OF THE DRAWINGS

In order to illustrate the technical solutions in the embodiments of the present application more clearly, the following will briefly introduce the drawings needed in the description of the embodiments or the existing technology. Obviously, the drawings in the following description are merely some embodiments of the present application, for those of ordinary skill in the art can obtain other drawings on the basis of these drawings without creative labor.

FIG. 1 is a schematic structural diagram of an oral irrigator in accordance with an embodiment of the present application;

FIG. 2 is a schematic diagram of an internal structure of the water tank in FIG. 1;

FIG. 3 is a schematic diagram of a partial enlarged structure of FIG. 2;

FIG. 4 is a schematic structural diagram of a cathode plate and an anode plate in FIG. 3;

FIG. 5 is a schematic cross-sectional structure diagram of the oral irrigator in accordance with an embodiment of the present application;

FIG. 6 is a schematic diagram of a partial enlarged structure taken from FIG. 5; and

FIG. 7 is a schematic cross-sectional view of the cathode plate and the anode plate shown in FIG. 6.

Reference numerals in the drawings are listed as follows: 1 water tank; 2 cathode plate; 3 anode plate; 4 water outlet; 5 nozzle; 6 irrigator body; 7 opening; 8 through hole; 9 insulating annular seal; 10 pump body; 11 motor.

### DETAILED DESCRIPTION OF THE EMBODIMENTS

In order to make the technical problem to be solved, technical solutions and beneficial effects of the present application more comprehensible, the present application will be further described in detail below with reference to the accompanying drawings and embodiments. It should be understood that the embodiments described here are merely used to illustrate the present application, and are not intended to limit the present application.

It should be noted that when an element is referred to as being “fixed to” or “disposed/provided on” another element, it may be directly or indirectly on the other element. When an element is referred to as being “connected to” another element, it may be directly or indirectly connected to the other element.

In addition, the terms “first” and “second” are only used for descriptive purpose, and cannot be understood as indicating or implying relative importance or implicitly indicating the number of indicated technical features. Thus, the features defined with “first” and “second” may explicitly or implicitly include one or more of these features. In the description of the present application, the term “a/the plurality of” means two or more, unless otherwise specifically defined. The word “several” means one or more, unless otherwise specifically defined.

In the description of the present application, it should be understood that direction or position relationship indicated by terms “center,” “length,” “width,” “upper,” “thickness,” “lower,” “front,” “back,” “left,” “right,” “vertical,” “horizontal,” “top,” “bottom,” “inner,” “outer” and the like, are based on the orientation or position relationship shown in the drawings, which are merely used for the convenience of describing the present application and simplifying the description, rather than indicating or implying that the device or element referred to must have a specific orientation, be constructed and operated in a specific orientation, it thus cannot be understood as a limitation to the present application.

In the description of the present application, it should be noted that, unless otherwise clearly specified and defined, the terms “installed/mounted,” “coupled to”, and “connected to/with” should be understood in a broad sense. For example, it may be a fixed connection or a detachable connection, or an integrated connection. It may be mechanically connected or electrically connected. It may be directly connected or may be indirectly connected through an intermediate medium. It may be an internal communication between two components or an interaction relationship between two components. For those of ordinary skill in the art, the specific meaning of the above-mentioned terms in the present application can be understood according to specific circumstances.

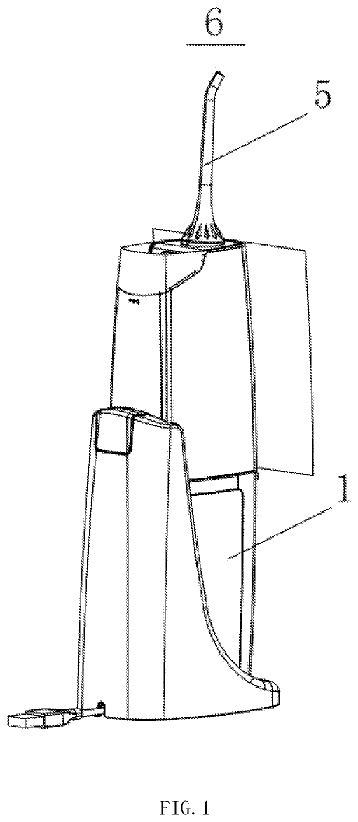

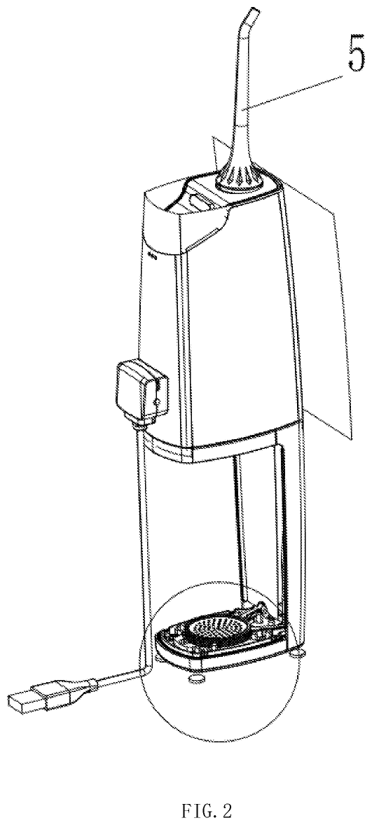

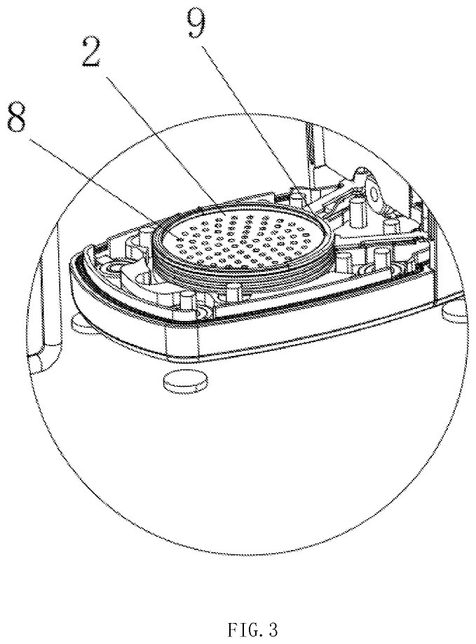

Referring to FIGS. 1-7, the present application provides a specific embodiment of an oral irrigator, including an irrigator body 6. The irrigator body 6 includes a water tank 1, a nozzle 5. At least one cathode plate 2 and at least one anode plate 3 are provided at a bottom of the water tank 1 being spaced apart and alternately arranged. The cathode plate 2 and the anode plate 3 are electrically connected to a negative electrode and a positive electrode of a power supply component of the irrigator body 6, respectively. A water outlet 4 of the water tank 1 is located at the bottom of the water tank 1. Water in the water tank 1 is electrolyzed by the cathode plates 2 and the anode plates 3 to generate ozone water and hydrogen-rich water, and the ozone water and hydrogen-rich water flow out from the water outlet 4 to the nozzle 5 of the irrigator body 6 to be sprayed out.

Specifically, the basic structure of the irrigator body 6 includes a water tank 1, a pump body 10, a motor 11, a nozzle 5, and a power supply component. The power supply component may be a battery that is chargeable and dischargeable. The power supply component provides power to the motor 11 which drives the pump body 10 to run. Driven by the pump body 10, the water in the water tank 1 is sprayed out from the nozzle 5 to flush an oral cavity of human body. In this embodiment, the bottom of the water tank 1 is provided with the cathode plates 2 and the anode plates 3 arranged at intervals. In which, the cathode plates 2 are electrically connected to the negative electrode of the power supply component, and the anode plates 3 are electrically connected to the positive electrode of the power supply component. When energized, water in the water tank 1 can by electrolyzed by the cathode and anode plates at low pressure to generate ozone water and hydrogen-rich water, the ozone water and hydrogen-rich water flow out from the water outlet 4, and then are sprayed out from the nozzle 5 under the drive of the pump body 10, such that the oral cavity of human body can be cleaned with the ozone water and hydrogen-rich water.

In this embodiment, since ozone water and hydrogen-rich water are generated under an action of low-pressure electrolysis, the oral cavity of the human body can be cleaned by the ozone water and hydrogen-rich water.

Among them, the generated ozone water has a care effect on human oral cavity in that it can quickly and effectively kill virus bacteria such as tuberculosis, Escherichia coli, gonococcus, typhoid bacillus, etc. as well as harmful microorganisms in the teeth and the oral cavity. It can also produce sterile water, which is good for human body and is harmless. It yet can remove bad breath and bleach tooth discoloration and dirt.

Among them, the generated hydrogen-rich water has a care effect on human oral cavity in that it can eliminate excessive active oxygen free radicals in the human body and improve the sub-health state of the human body. It also has strong antioxidant capacity and can improve the oxidative damage to the human body in the process of various diseases.

In this embodiment, the cathode plate 2 and the anode plate 3 are located at the bottom of the water tank 1, which will not occupy too much internal space of the water tank 1, and the generator is small in size, which does not affect the water storage capacity of the water tank 1, such that more uniform and high-concentration ozone water and hydrogen-rich water can be obtained. Moreover, in this embodiment, it is unnecessary for the cathode plate 2 and the anode plate 3 to be equipped with a short-circuit prevention structure during the electrolysis of water, which greatly improves a convenience and immediacy of water electrolysis, thus the ozone water and hydrogen-rich water can be generated more stably and continuously, achieving a more complete electrolysis, thereby higher concentrations of ozone water and hydrogen-rich water can be obtained.

Specifically, the number of the cathode plate 2 and the anode plate 3 may be multiple, and the two may be arranged horizontally and alternately arranged along a vertical direction. Specifically, the uppermost plate may be the cathode plate 2, and the followed lower one is the anode plate 3, and then the cathode plate 2, and so on, or the uppermost is the anode plate 3, the followed lower one is the cathode plate 2, and then the anode plate 3, and so on.

Specifically, the number of the cathode plate 2 and the anode plate 3 may both be two, and the four electrode plates may be arranged alternately. Or alternatively, the number of the cathode plate 2 and the anode plate 3 may both be one, and the two electrode plates may be arranged in the form of up and down. Of course, other numbers are also possible.

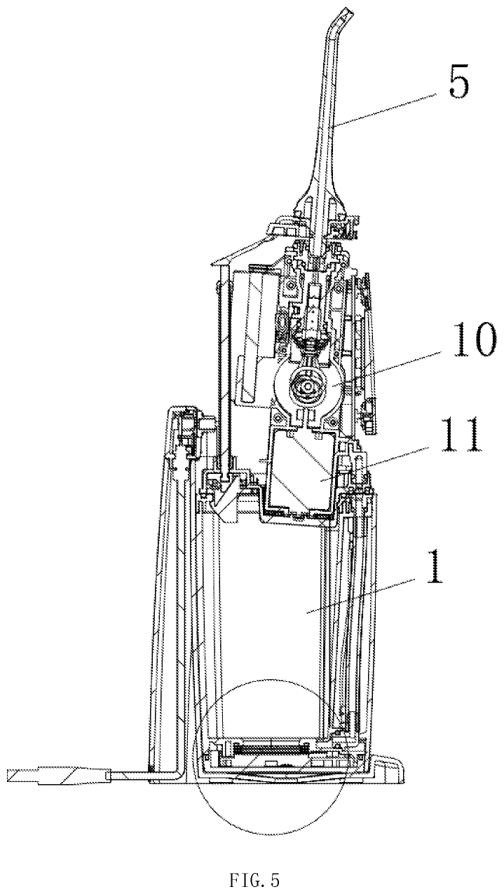

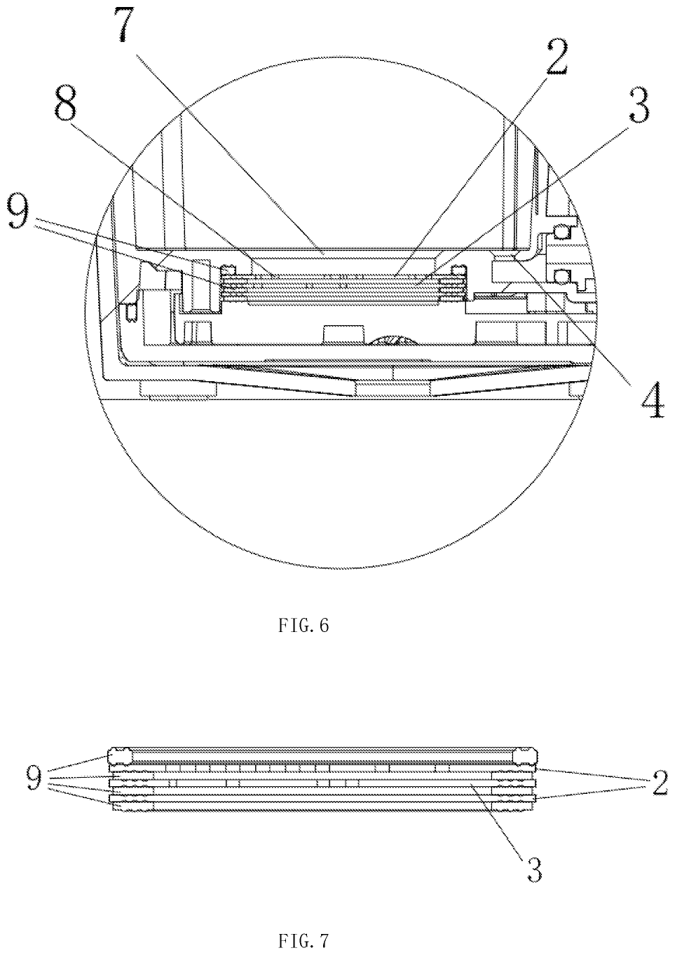

As shown in FIGS. 5 and 6, in one embodiment, in order to increase the privacy and safety of the cathode plate 2 and the anode plate 3, so as to further reduce the space occupation of the water tank 1, this embodiment provides a chamber at a bottom plate. The bottom plate is the bottom of the water tank 1, which may be integrally formed with the water tank 1, or may has a separated structure. When the bottom plate has a separated structure, it is hermetically mounted at the bottom of the water tank 1 to seal the water tank 1, that is, the bottom plate is an independent unit, and the interior of the bottom plate forms a chamber. The cathode plate 2 and the anode plate 3 are arranged in the chamber, such that an independent ozone water/hydrogen-rich water generator is formed in the bottom plate. As the water in the water tank 1 must be flowed into the chamber, the chamber is provided with an opening 7 for water inflow. The water is electrolyzed in the chamber to generate ozone water and hydrogen-rich water. The water outlet 4 of the water tank 1 is also arranged at the bottom of the water tank 1, so that the ozone water and hydrogen-rich water can flow out directly through the water outlet 4 to the nozzle 5 to be sprayed out to clean the oral cavity of human body.

The chamber in this embodiment is located at the bottom of the water tank 1, which does not occupy the space of the water tank 1. The chamber has an independent structure, which provides a better safety. The water in the water tank 1 can enter the chamber through the opening 7, and a low-voltage electrolysis occurs between the cathode plate 2 and the anode plate 3 to generate ozone water and hydrogen-rich water. After being generated, the ozone water and hydrogen-rich water can flow out again from the opening 7 and enter the water outlet 4 of the water tank 1 and then be sprayed out from the nozzle 5 by means of the pump body 10.

The cathode plate 2 and the anode plate 3 have a plate-like structure. The two are connected with conductive sheets, which extend out of the chamber, and are then connected to the negative and positive electrodes of the power supply component through wires. The wires are located outside the water tank 1 and outside the water tank 1, a layer of shell-shaped body is also provided for wrapping the wire and extending to the power supply component. That effectively ensures the safety of the wire and increases a service life.

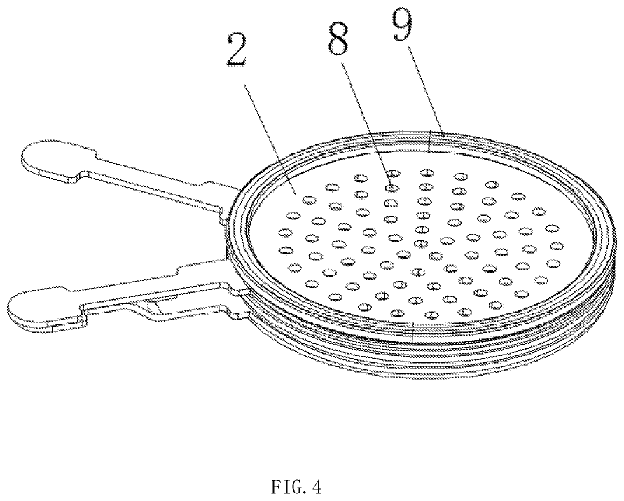

As shown in FIGS. 4 and 7, as a preferred embodiment of the present application, it is preferably provided with two cathode plates 2 and one anode plate 3. The anode plate 3 is located between the two cathode plates 2 so that the water between the anode plate 3 and the cathode plate 2 is electrolyzed. The water is able to flow between the anode plate 3 and the cathode plate 2 after entering through the opening 7, thereby electrolysis occurs. Or alternatively, it may also be provided with two anode plates 3 and one cathode plate 2, specifically, the cathode plate 2 is located between the two anode plates 3, and the electrolysis can also occur.

In this embodiment, it is provided two cathode plates 2 and one anode plate 3, the number of electrode plates is not very large, this is because the amount of water in the water tank 1 for flushing teeth is relatively small, so there is no need to provide too many electrode plates. Moreover, the power supply component has limited power storage, thus only two cathode plates 2 and one anode plate 3 may be enough. Furthermore, it may also be in the form of one cathode plate 2 and one anode plate 3, which can be selected according to actual needs.

Specifically, an input condition for the low-voltage electrolysis power supply may be a DC power supply below 12-20V and a constant current below 600 mA. In the application of the electrolysis structure in the oral irrigator, the cathode and anode plates do not need to be a short-circuit prevention structure.

Further, a distance between adjacent cathode plate 2 and anode plate 3 is less than or equal to 1 mm. The distance between the two has a maximum of 1 mm only, that is, only a thin layer of water is provided between the cathode plate 2 and the anode plate 3, so that the water between the anode plate 3 and the cathode plate 2 can be fully and thoroughly electrolyzed. As water exchange is completed through the flow of water, continuous electrolysis of water can be fully carried out in large quantities, thereby producing higher concentration of ozone water and hydrogen-rich water.

Due to the small distance between the cathode plate 2 and the anode plate 3, the water can be fully electrolyzed, so that the continuous electrolysis of water can be carried out to produce high-concentration ozone water and hydrogen-rich water.

In one of the embodiments, the cathode plate 2 and the anode plate 3 both have a material of titanium alloy.

The titanium alloy can work at very high temperature, which can work for a long time at a temperature of 450-500° C., and has strong corrosion resistance in a humid environment. It also has strong resistance to pitting corrosion, acid corrosion and stress corrosion, and has excellent corrosion resistance to chloride, chlorine organic products, nitric acid, sulfuric acid, etc. Therefore, the use of titanium alloy can ensure the use effect, prolong the service life, and avoid a repeated replacement of the electrode plate.

Further, as shown in FIGS. 5 and 6, the chamber is located in the bottom plate. In order to allow the water in the water tank 1 to flow in, an opening 7 is provided on a surface of the bottom plate, that is, at a top of the chamber. The opening 7 at the top of the chamber is disposed on the bottom plate of the water tank 1, and below the opening 7 the cathode plates 2 and the anode plates 3 are provided directly, that is, the cathode plates 2 and the anode plates 3 are aligned with the opening 7. Such that the water can directly reach a position where the electrode plates are located when it enters the chamber thereby facilitating an electrolysis. In order to prevent the electrode plates from obstructing the water flow, through holes 8 are disposed on the electrode plates, except for the electrode plate located farthest from the opening 7. That is, the electrode plates located between the opening 7 and the electrode plate located farthest from the opening 7 are provided with through holes 8 to facilitate a flowing of water.

Therefore, in this embodiment, the electrode plate is facing the opening 7, and the water flow can directly enter between the electrode plates to facilitate electrolysis, and the electrode plate is also provided with through holes 8 to avoid the electrode plate obstructing the water flow, such that the water can be filled between the electrode plates.

As shown in FIGS. 4, 6 and 7, in one of the embodiments, between the adjacent cathode plate 2 and anode plate 3, between the cathode plate 2 at the bottom and a bottom surface of the chamber, and between the cathode plate 2 at the top and a top surface of the chamber, insulating annular seals 9 are provided respectively. The opening 7 is located in an inner side of the insulating annular seal 9 between the cathode plate 2 at the top and the top surface of the chamber.

Specifically, since the insulating annular seal 9 is disposed at the above positions, when the water flow enters the chamber from the opening 7, it is equivalent to entering a closed enclosure surrounded by the insulating annular seal 9, the electrode plate, and the top surface of the chamber. In this enclosed area, the electrode plates are arranged, the water flow is limited in this area and will not flow to other areas of the chamber, so that the water can be electrolyzed more effectively, and the other areas of the chamber has no entries for the water flow, which can effectively ensure the safety of devices in the other areas and prevent the devices from being immersed by water flow. The insulating annular seal 9 also plays a role of isolating adjacent electrode plates, and maintaining a preset inherent spacing between the electrode plates.

As shown in FIG. 5, in one of the embodiments, the irrigator body 6 further includes a pump body 10 and a motor 11. The motor 11 is used for power output and transmits the power to the pump body 10 so that the pump body 10 can transport the water at the bottom of the water tank 1 to the nozzle 5 of the irrigator body 6 to be sprayed out. The water outlet 4 of the water tank 1 is connected to an inlet of the pump body 10, so that ozone water and hydrogen-rich water can be sprayed out.

This embodiment provides the basic structure of the irrigator body 6 to achieve an effect that ozone water and hydrogen-rich water can be sprayed out from the nozzle 5, so that the oral irrigator obtains the technical effect of being able to provide ozone water and hydrogen-rich water.

Further, the cathode plates 2 and the anode plates 3 have a circular shape. The circular cathode plates 2 and anode plates 3 provides the largest effective utilization area, that is, for shapes of the same circumference, a circular has the largest area, which can effectively increase the electrolysis area with the smallest occupied space. The shape of the circular electrode plate also matches that of the opening 7, that is, the opening 7 also has a circular shape.

Further, the inlet of the pump body 10 is connected to the water outlet 4 of the water tank 1 through a connection pipe. The connection pipe is located outside the water tank 1, and the outside of the connection pipe is also wrapped with a layer of shell-shaped body, and the connection pipe and the above-mentioned wire are both wrapped, which can effectively ensure that the two are not damaged by external factors.

The above descriptions are merely some preferred embodiments of the present application, and are not intended to limit the present application. Any modification, equivalent replacement and improvement made within the spirit and principle of the present application shall be included within the protection scope of the present application.

What is claimed is:

1. An oral irrigator, comprising:
an irrigator body, the irrigator body comprising:
a power supply component, having a negative electrode and a positive electrode;
a water tank, comprising:
a water outlet being located at a bottom of the water tank,
at least one cathode plate and at least one anode plate are provided at the bottom of the water tank, being spaced apart and alternately arranged, the at least one cathode plate and the at least one anode plate being electrically connected to the negative electrode and the positive electrode of the power supply component, respectively, and
a nozzle,
wherein water in the water tank is electrolyzed by the at least one cathode plate and the at least one anode plate to generate ozone water and hydrogen-rich water, and the ozone water and hydrogen-rich water flow out from the water outlet to the nozzle of the irrigator body to be sprayed out.

2. The oral irrigator according to claim 1, wherein a chamber is provided in a bottom plate of the water tank, the at least one cathode plate and the at least one anode plate are provided in the chamber, and the chamber is provided with an opening in communication with the water tank.

3. The oral irrigator according to claim 2, wherein two cathode plates and one anode plate are provided, and the anode plate is located between the two cathode plates.

4. The oral irrigator according to claim 1, wherein a distance between adjacent cathode plate and anode plate is less than or equal to 1 mm.

5. The oral irrigator according to claim 1, wherein the at least one cathode plate and the at least one anode plate both have a material of titanium alloy.

6. The oral irrigator according to claim 2, wherein the opening is disposed on a surface of the bottom plate, the at least one cathode plate and the at least one anode plate are aligned with the opening, the at least one cathode plate and the at least one anode plate are respectively provided with a plurality of through holes except for a cathode/anode plate located farthest from the opening.

7. The oral irrigator according to claim 3, wherein, between the adjacent cathode plate and anode plate, between the cathode plate at the bottom and a bottom surface of the chamber, and between the cathode plate at the top and a top surface of the chamber, insulating annular seals are provided respectively, and the opening is located at an inner side of the insulating annular seal between the cathode plate at the top and the top surface of the chamber.

8. The oral irrigator according to claim 1, wherein the irrigator body further comprises a pump body and a motor matching the pump body, an inlet of the pump body is in communication with the water outlet of the water tank, and an outlet of the pump body is in communication with the nozzle of the irrigator body.

9. The oral irrigator according to claim 1, wherein the at least one cathode plate and the at least one anode plate are circular in shape.

10. The oral irrigator according to claim 8, wherein the inlet of the pump body is connected to the outlet of the water tank through a connection pipe.
